(19) United States
(12) Patent Application Publication
(10) Pub. No.: US 2017/0206550 A1
(43) Pub. Date: Jul. 20, 2017

(54) USER UTILITY BASED OFFERS

(71) Applicant: Google Inc., Mountain View, CA (US)

(72) Inventors: Fergus Gerard Hurley, San Francisco, CA (US); Michael Schwarz, Berkley, CA (US); Robin Dua, San Francisco, CA (US); Sangsoo Sung, Palo Alto, CA (US); Andrew Tomkins, San Jose, CA (US)

(21) Appl. No.: 14/313,432

(22) Filed: Jun. 24, 2014

(51) Int. Cl. G06Q 30/02

(52) U.S. Cl. CPC G06Q 30/0251; G06Q 30/0275

(57) ABSTRACT

Methods, systems, and apparatus for allocating an offer based, in part, on a user's utility. In one aspect, a method includes receiving, at a data processing apparatus, data describing a purchase intent for a set of items, the purchase intent being for a user; receiving, at the data processing apparatus, from each offeror in a set of offerors: a corresponding offer from the offeror, each offer applying to one or more items in the set of items, and a corresponding valuation of the offer by the offeror for presentation of the offer to the user; for each offer in the set of offers, determining, by the data processing apparatus, a corresponding utility to the user based on a user utility model, and adjusting the valuation for the offer based on the corresponding utility determined for the offer to generate an adjusted valuation for the offer.

### BACKGROUND

The Internet enables access to a wide variety of resources, e.g., video and/or audio files, web pages for particular subjects, news articles, etc. Such access to these resources has likewise enabled opportunities for providing additional content, such as advertisements. A variety of content selection schemes are in use, each of which focuses on a particular feature or set of features by which the additional content may be selected. In the case of advertisements, for example, keyword selection, remarketing lists, location based information and the like are used to provide advertisements that may be of interest to the user.

### SUMMARY

This specification describes technologies relating to providing content, such as advertisements/offers, to a user based on estimated utility of the offer to the user.

In general, one innovative aspect of the subject matter described in this specification can be embodied in methods that include the actions of receiving, at a data processing apparatus, data describing a purchase intent for a set of items, the purchase intent being for a user; receiving, at the data processing apparatus, from each offeror in a set of offerors: a corresponding offer from the offeror, each offer applying to one or more items in the set of items, and a corresponding valuation of the offer by the offeror for presentation of the offer to the user; for each offer in the set of offers, determining, by the data processing apparatus, a corresponding utility to the user based on a user utility model, and adjusting the valuation for the offer based on the corresponding utility determined for the offer to generate an adjusted valuation for the offer. Other embodiments of this aspect include corresponding systems, apparatus, and computer programs, configured to perform the actions of the methods, encoded on computer storage devices.

Particular embodiments of the subject matter described in this specification can be implemented so as to realize one or more of the following advantages. Providing offers based, in part, on user utility incentivizes the offeror to focus on the user utility so as to realize more efficient placement of offers. The user utility measure can be a component in addition to offeror bids and non-user utility related quality factors when determining offer placement in, for example, an auction. This, in turn, tends to result in offers with higher user utility being served to users before offers with lower user utility, especially when all other factors are balanced. Furthermore, the overall experience from both the user and offeror is enhanced. The user realizes a higher utility from offers that are selected, in part, based on user utility. Similarly, the higher the user utility, the lower the cost of the offer placement for the offeror, and thus the offeror's return on investment for offer placements is increased.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which offers based on user utility are provided.

FIG. 2 is a flow diagram of an example process for providing offers based on user utility.

FIG. 3A is a flow diagram of an example process for quantifying user utility of an offer.

FIG. 3B is an illustration of an acceptance probability distribution.

FIG. 4 is an illustration of a user interface at a user device in which an offer based on user utility is presented.

FIG. 5 is a block diagram of an example mobile computing device.

Like reference numbers and designations in the various drawings indicate like elements.

### DETAILED DESCRIPTION

A system for providing content based on user utility takes into account an expected utility of a user for an offer related to a set of one or more items the user may intend to purchase. Data describing a purchase intent for a set of items—e.g., a list of items—for a user is provided. Offerors each provide a corresponding offer that applies to one or more items in the set of items, and each offer has a corresponding valuation by the offeror that represents a value to the offeror for presentation of the offer to a user. In some implementations, the valuation is an auction bid that represents an amount the offeror is willing to pay for presentation of the offer to the user. For each offer, the system determines a corresponding utility to the user. The utility of an offer is the ability of the offer to satisfy the needs or wants of the user. While the utility of an offer may be subjective for each user, the utility of the offer can be measured objectively for a large number of uses and quantified according to a utility model. A variety of quantification schemes can be used. As will be described in more detail below, the utility of an offer is quantified by a model, and the quantification is used to generate an adjustment of a bid for placement of an offer. A variety of utility models can be used, and the utility model can take various offers and quantify them into a measure of user utility. For each offer, the bid for the offer based on the corresponding utility determined for the offer is adjusted to generate an adjusted bid for the offer. The adjusted bid is then used as one input to an offer selection process, such as an auction, to select an offer for presentation to the user.

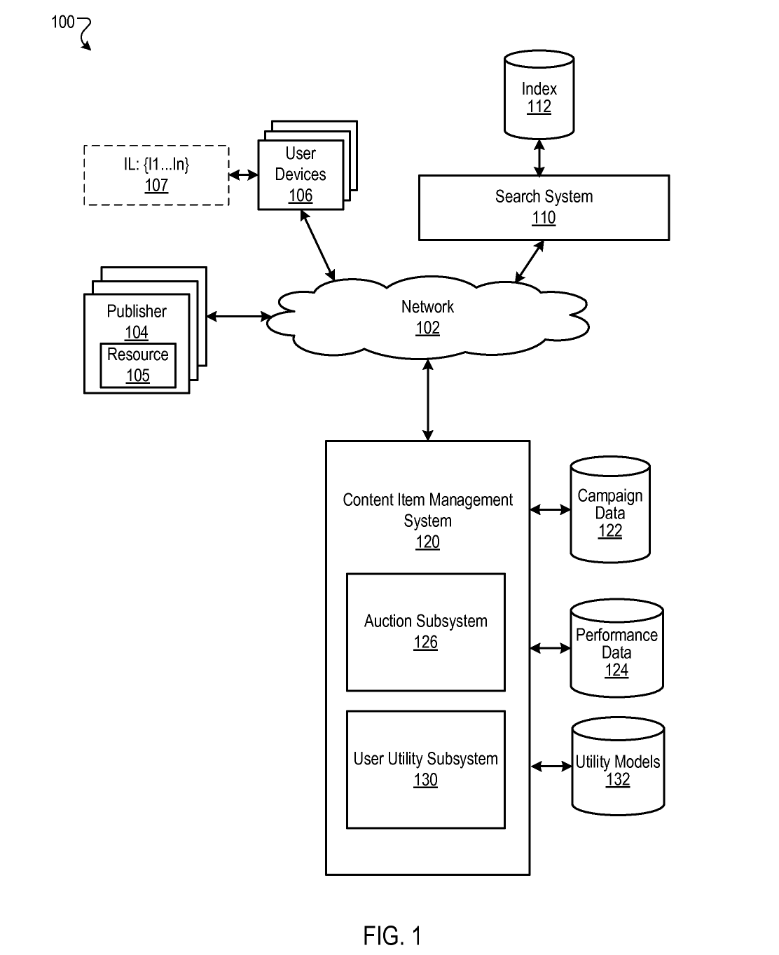

FIG. 1 is a block diagram of an example environment 100 in which offers based on user utility are provided. A computer network 102, such as the Internet, connects publisher web sites 104, user devices 106, and the search engine 110, and content item management system 120. The online environment 100 may include many thousands of publisher web sites 104 and user devices 106.

A website 104 includes one or more resources 105 associated with a domain name and hosted by one or more servers. An example website is a collection of web pages formatted in hypertext markup language (HTML) that can contain text, images, multimedia content, and programming elements, such as scripts. Each website 104 is maintained by a content publisher, which is an entity that controls, manages and/or owns the website 104.

A resource is any data that can be provided by the publisher 104 over the network 102 and that is associated with a resource address. Resources include HTML pages, images, videos, and feed sources, to name just a few. The resources can include content, such as words, phrases, pictures, and so on, and may include embedded information (such as meta information and hyperlinks) and/or embedded instructions (such as scripts).

A user device 106 is an electronic device that is under the control of a user and is capable of requesting and receiving resources over the network 102. Example user devices 106 include personal computers, mobile communication devices, and other devices that can send and receive data over the network 102. A user device 106 typically includes a user application, such as a web browser, to facilitate the sending and receiving of data over the network 102. The web browser can enable a user to display and interact with text, images, videos, music and other information typically located on a web page at a website on the world wide web or a local area network.

To facilitate searching of these resources 105, the search engine 110 identifies the resources by crawling the publisher web sites 104 and indexes the resources provided by the publisher web sites 104. The user devices 106 submit search queries to the search engine 110. In response, the search engine 110 uses the index 112 to identify resources that are relevant to the queries. The search engine 110 identifies the resources in the form of search results and returns the search results to the user devices 106 in a search results page resource. A search result is data generated by the search engine 110 that identifies a resource that satisfies a particular search query, and includes a resource identifier for the resource. An example search result can include a web page title, a snippet of text extracted from the web page, and the URL of the web page.

The user devices 106 receive the search results pages and render the pages for presentation to users. In response to the user selecting a search result at a user device 106, the user device 106 requests the resource identified by the resource locator included in the selected search result. The publisher of the web site 104 hosting the resource receives the request for the resource from the user device 106 and provides the resource to the requesting user device 106.

The content item management system 120 facilitates the provisioning of additional content with the resources 105. One example content item management system 120 is an advertisement management system that provides advertisement content items. As used in this application, an advertiser may also be referred to as an “offeror,” and an advertisement may be referred to as an offer. Typically an offer will have some utility for the user.

For the remainder of this document, the content item management system is described in the example context of an advertisement manage system 120. However, other types of content item management systems can be used, such as application provider systems, media provider systems, etc.

The advertisement management system 120 allows advertisers to define selection rules that take into account attributes of the particular user to select advertisement offers for the users. Example selection rules include keyword selection, in which advertisers provide bids for keywords that are present in either search queries or webpage content.

These advertisements can be provided for many different resources, such as the resources 105 of the publishers 104, and on a search results page resource. For example, a resource 105 from a publisher 104 includes instructions that cause the user device to request advertisements from the advertisement management system 120. The advertisement management system 120, in turn, provides advertisements to the particular user device. With respect to a search results page, the user device 106 renders the search results page and sends a request to the advertisement management system 120. The advertisement management system 120, in turn, provides advertisements to the particular user device.

The advertisement management system 120 includes a data storage system that stores campaign data 122 and performance data 124. The campaign data 122 stores advertisements, selection information, and budgeting information for advertisers. The performance data 124 stores data indicating the performance of the advertisements that are served. Such performance data can include, for example, click through rates for advertisements, the number of impressions for advertisements, and the number of conversions for advertisements.

A “conversion” occurs when a user performs a desired action in response to an advertisement/offer. For example, a conversion occurs when a user consummates a transaction related to a previously served advertisement, or performs an action that is specified by an offer in the advertisement. What constitutes a conversion may vary from case to case and can be determined in a variety of ways. A conversion may be defined as a user being shown an advertisement, and making a purchase on the advertiser's web page or at the advertiser's store within a predetermined time (e.g., seven days). In the case of the latter, for example, a user may select the advertisement to redeem an offer coupon that uniquely corresponds to the impression of the offer to facilitate conversion tracking.

Other performance data can also be stored.

The campaign data 122 and the performance data 124 are used as input parameters to an advertisement auction subsystem 126. In particular, the advertisement management system 120, in response to each request for advertisements, conducts an auction to select advertisements that are provided in response to the request. The advertisements are ranked according to an auction score that, in some implementations, is proportional to a value based on an advertisement bid and one or more parameters specified in the performance data 124. The highest ranked advertisements resulting from the auction are selected and provided to the requesting user device.

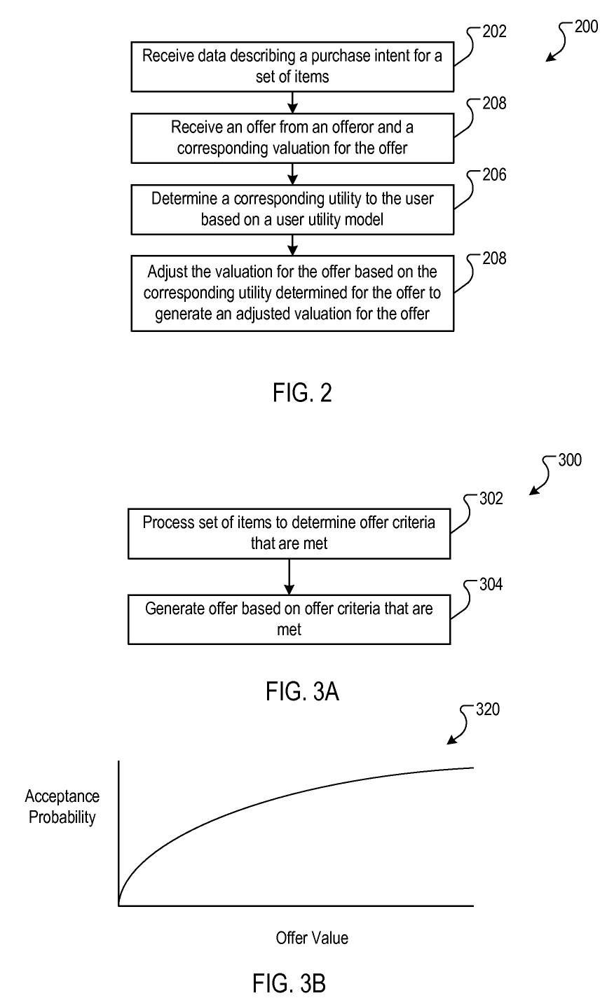

The advertisement management system 120 includes a user utility subsystem 130 that processes terms of an offer of an advertisement and quantifies the utility of the offer using one or more user utility models 132. Operation of the user utility subsystem 130 is described with reference to FIG. 2 below, which is a flow diagram 200 of an example process for providing offers based on user utility. The process 200 can be implemented in a data processing apparatus that is used to realize the user utility subsystem 130. The process 200 is described with reference to one offeror. However, the process 200 is typically performed for multiple offerors, each of which submits competing offers. While described as an element of advertisement management system 120, user utility subsystem 130 may alternatively be part of another system or a stand-alone system.

Furthermore, in the example that follows, a user intent that is a purchase intent for a set of items is described. However, other user intents, such as a lease or rent intent, an exchange intent, a trade intent, etc. may also be used.

The user utility subsystem 130 receives data describing a purchase intent for a set of items (202). For example, the user utility subsystem 130 receives data describing a set of items for a user. The set of items can be goods, both tangible and intangible, and/or services, and the set may include only one item or multiple items. For example, a user may have a list of items IL, as indicated by the phantom list 107 of FIG. 1. The list IL may include as few as 1 item, or up to n items Il . . . In. Example lists include shopping lists, such as a grocery list in a grocery listing application, or items in an electronic shopping cart, and the like. Typically the list is populated by the user, but in some implementations, the list may be auto-populated, such as by a recurring list that the user has configured.

The data describing the purchase intent for the user can be sent to the user utility subsystem 130 in response to the user opening a web page in which the list of items is displayed, or opening an application environment in which the list of items is displayed. Alternatively, a user device need not display the list of items for the data to be sent to the user utility subsystem 130. For example, the user utility subsystem 130 may receive the list from an on-line retailer, and the advertisement management system 120 may provide advertisements that include offers as the user browses other resources.

The user utility subsystem 130 receives an offer from an offeror and a corresponding valuation for the offer (204). The offer applies to one or more items in the set of items, and the valuation indicates a value to the offeror to have the offer presented to a user. For example, the valuation can be an auction bid representing an amount the offeror is willing to pay in an auction for presentation of the offer to the user. The bid may be a null bid, e.g., zero currency, or may be a positive bid, e.g., a non-zero currency sum. As will be described below, a null bid may be adjusted by the utility determined for the offer.

Other valuations and selection processes can also be used. For example, the valuation may be expressed in terms of data the offeror may provide to the content item management system 120. Such data may include information regarding user purchases, for example. Valuations may also be expressed in terms of an incentive offered. For example, the offeror may itself be incentivized to offer a free sample of discount for a product.

Another type of valuation is a repeat customer valuation. The valuation may be expressed in terms of a percentage of sales or fixed fee for each subsequent visit by the user to the offeror. For example, grocery store may provide a valuation of $0 for acceptance of the offer, and $1.00 for each subsequent visit to the grocery store by the user, up to a maximum number of visits, such as 10 visits. Other valuation types may also be used.

In some implementations, an offer specifies an incentive to accept the offer, and the incentive is determined by the offeror. Thus, for multiple offerors, the offers may specify different incentives. The offer may be specified in a variety of ways. For example an offeror may have a fixed offer for all purchasing incentives, e.g., 2% for all in-store purchases, for example. By way of another example, an offeror may determine incentives based on the set of items described by the received data. FIG. 3A is a flow diagram of an example process 300 for generating an offer for the latter example. The process 300 may be implemented in a data processing apparatus of an offeror, or, alternatively, implemented in the user utility subsystem 130 based on selection criteria data provided by the offerors. In the example description that follows, the process is implemented in the user utility subsystem 130.

The user utility subsystem 130 processes a set of items to determine offer criteria that are met (302). The offer criteria specify conditions that must be met for certain offers. Various criteria can be used, such as item-specific criteria that are satisfied by one item being present in the list, or item combination criteria that are satisfied by combinations of items. For example, a first offer criterion may be met with a “milk” item is included in a list; a second offer criterion may be met with a combination of “milk” and “eggs” items are included in a list. The criteria can also include negative criteria. For example, a third offer criterion may be met with a combination of “milk” and “eggs” items are included in a list, and the item of “strawberries” is not included in the list.

Another criteria type may be price. For example, an offer criterion may be met when the total price of items in a list meets a threshold price, or is less than the threshold price.

Location can also be used as a criterion. If, for example, the list of items also species a physical location, such as a certain store of an offeror, then a criterion for a location-specific offer may be met.

A variety of other appropriate offer criteria can also be used, such as date or time of delivery, delivery all-together or piecemeal, mode of delivery, acceptability of alternative items or services (or item source or service provider), and so on.

Based on the offer criteria that are met, the user utility subsystem 130 generates an offer (304). One or more offers may be generated, and each may be submitted for selection by the auction subsystem 126. For example, the offer may specify offer terms that specify an action and an incentive to perform the action. One example offer type may be a purchase offer that species a purchase action and a price incentive for the purchase. For example, several grocery advertisers may compete for the user's business with respect to a list of grocery items. Each offer requires an action that the user purchase the items at the respective offeror's store, and each offer may specify a purchase incentive. One incentive may be a percentage discount on a total price for all of the items in the set of items, another may be an incentive to purchase an additional item not included in the set of items at a substantial discount, and so on. Each incentive is specified by the offeror, and the selection of an incentive to include in an offer is dependent on the criteria that are satisfied by the set of items.

Returning now to FIG. 2, the user utility subsystem 130 determines a corresponding utility to the user based on a user utility model (206). In some implementations, the user utility subsystem can be a generalized utility model expressed according to the following equation:

$$U = {\int }_{c 1}^{c 2} h ( c ) d c$$

where:
h(c) is a function that estimates the probability that a user accepts an offer to purchase at a price c; and
U is a quantification of the utility given a price range.

The values of c1 and c2 may vary. In some implementations, c1 is a first price for goods or services purchased without any incentive, and c2 is a second price for goods or services purchased subject to the incentive. The values of c1 and c2 may thus be used to quantify the incentive of the offer, and this quantification may be provided to the probability function h(c) as input. The function h(c) can be a learned function, or can be a function generated from user evaluation inputs.

In the case of a learned function, the model may be trained on user history data specifying purchases of sets of items. The training data specifies at least a first subset of sets of items and a second subset of sets of items. The first subset of the the sets of items were purchased subject to an acceptance of respective offers applied to one or more items in each set of items and a corresponding incentive to accept the offer, and the second subset of sets of items were purchased subject to a rejection of respective offers applied to one or more items in each set of items and a corresponding incentive to accept the offer. In variations of this implementation, the training data can also include a third subset of the sets of items that were purchased not subject to an acceptance or rejection of an offer.

A variety of machine learning techniques can be used to estimate a probability of acceptance of a given offer with a feature set describing a set of times, the offer and the incentive.

In the case of user evaluation inputs, users, who may be volunteers or randomly selected, may be queried to determine whether they would accept an offer for a set of items given a particular incentive. The data can be collected and a corresponding probability curve can be generated, such as the example acceptance probability curve shown in FIG. 3B. In general, the probability curve will map over an incentive dimension, such as cost savings/discount offer value, and an acceptance probability dimension that describes the probability of acceptance given a particular offer value.

As described above, the utility function can be used to quantify the utility of an offer. For example, the user utility subsystem 130 may determine an undiscounted price for the set of items, apply the incentive to the set of items, and then determine, from the application of the incentive to the set of items, a discounted price. The incentive may then be quantified based on the difference between the undiscounted price and the discounted price.

Still other utility models can be used, and the utility models need not be probability based. For example, a utility model may provide a user valuation of an incentive, and the valuation may be substantially independent of the probability of acceptance of the offer. Furthermore, the valuation may be in monetary units, but may not have a 1:1 correspondence to a quantification of the incentive. For example, a user may have an offer to save $10 if he or she visits a store that competes with the store of which a user is a repeat customer. The user, however, may have brand loyalty that reduces the value of the $10 to the user savings significantly. Such valuation adjustments can be expressed by the users directly, or can be learned by machine learning techniques.

Finally, multiple utility models may be used. For example, one utility model may be used for “basket discounts,” another utility model may be used for “add-on items,” and so on. Each utility model is created and trained using offer data of the type that the utility model is being created to model.

After the utility is determined, the user utility subsystem 130 adjusts the bid for the offer based on the corresponding utility determined for the offer to generate an adjusted bid for the offer (208). In some implementations, the bid is adjusted according to the following function:

B′=B+A*U

where:
B is the bid of the offeror;
U is the utility; and
A is a scalar.

The value of A can be increased to provide more emphasis on user utility for offer placement during a selection process, or decreased to provide less emphasis on user utility for offer placement during the selection process.

The bid adjustments can be used for a variety of auction types, such as VCG or GSP auctions. Likewise, the bid adjustments can be used for a variety of bid types, such as eCPM based bids, and CPC based bids.

The user utility subsystem 130 submits the adjusted bid for offer to auction (210). The adjusted bid is used as the auction bid for the offeror. However, should the offeror's offer be selected, the offeror is only responsible for the offeror's original, unadjusted bid.

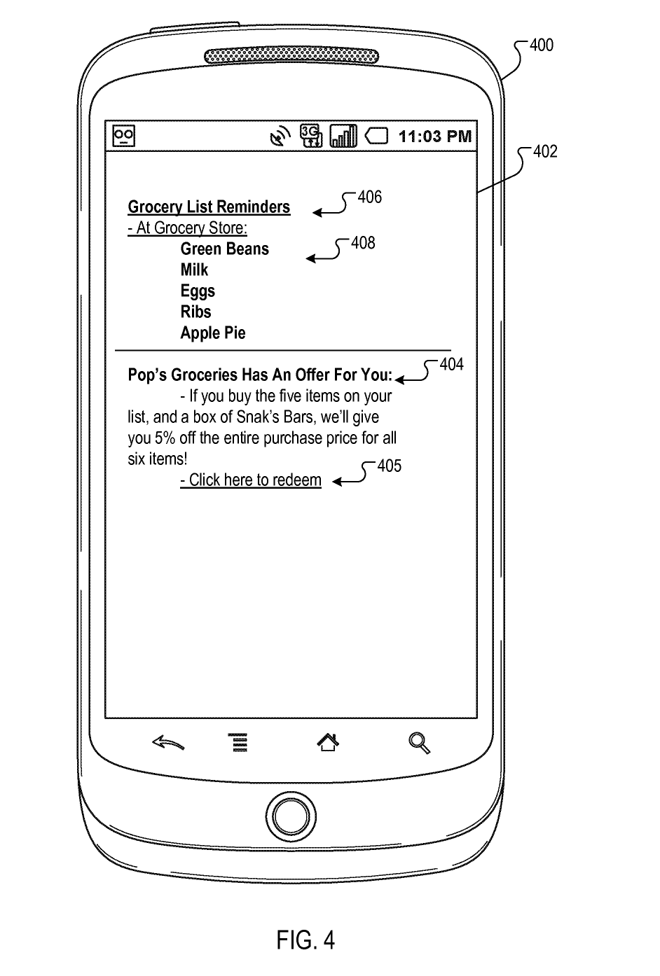

FIG. 4 is an illustration of a user interface 402 at a user device 400 in which an offer 404 based on user utility is presented. The offer 404 is shown with a grocery list reminder 406. The grocery list 408 describes the purchase intent for a set of grocery items.

The offer 404 shown is an offer that was selected in response to an auction performed by the auction subsystem 126 of FIG. 1. The offer 404 specifies an offer to purchase the five items in the list 108 and one addition item—“Snak's Bars”—in exchange of a discount price of 5%.

Tracking and evaluation of offer performance can be done in a variety of ways. For example, the offer 404 includes a link 405 that can be selected to redeem the offer. The offer may be redeemed by providing a coupon to the user. The coupon may be sent to the store location electronically, or may be sent to the mobile device 400. The user may then present the offer on the mobile device 400 for scanning during a check out process, for example.

Over time, the performance of the offers is collected and stored in the performance data 124. The user utility subsystem 124 may thus update the utility models 132 based on the performance of the offers.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

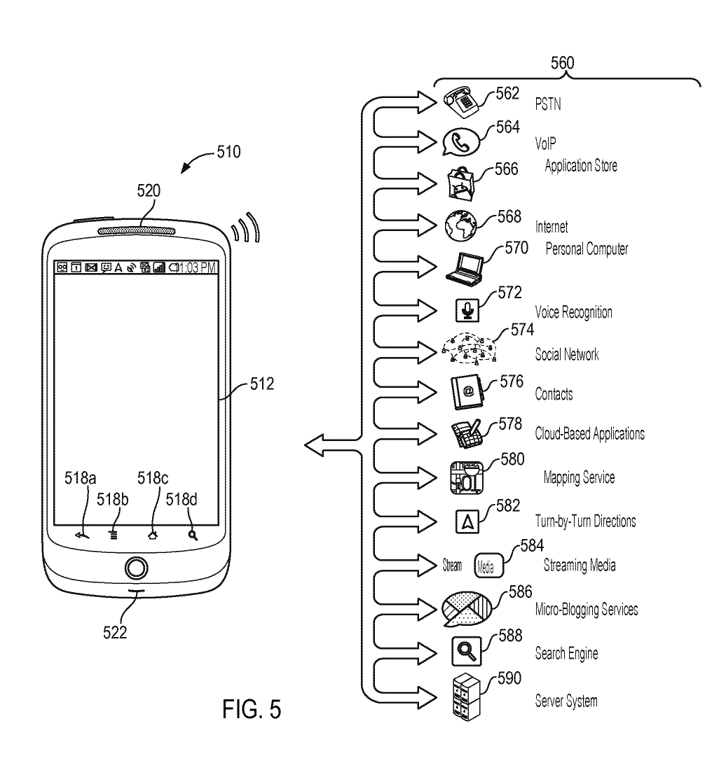

FIG. 5 is a block diagram of example mobile computing device. In this illustration, the mobile computing device 510 is depicted as a handheld mobile telephone (e.g., a smartphone, or an application telephone) that includes a touchscreen display device 512 for presenting content to a user of the mobile computing device 510 and receiving touch-based user inputs. Other visual, tactile, and auditory output components may also be provided (e.g., LED lights, a vibrating mechanism for tactile output, or a speaker for providing tonal, voice-generated, or recorded output), as may various different input components.

Example visual output mechanism in the form of display device 512 may take the form of a display with resistive or capacitive touch capabilities. The display device may be for displaying video, graphics, images, and text, and for coordinating user touch input locations with the location of displayed information so that the device 510 can associate user contact at a location of a displayed item with the item. The mobile computing device 510 may also take alternative forms, including as a laptop computer, a tablet or slate computer, a personal digital assistant, an embedded system (e.g., a car navigation system), a desktop personal computer, or a computerized workstation.

The mobile computing device 510 may be able to determine a position of physical contact with the touchscreen display device 512 (e.g., a position of contact by a finger or a stylus). Using the touchscreen 512, various “virtual” input mechanisms may be produced, where a user interacts with a graphical user interface element depicted on the touchscreen 512 by contacting the graphical user interface element. An example of a “virtual” input mechanism is a “software keyboard,” where a keyboard is displayed on the touchscreen and a user selects keys by pressing a region of the touchscreen 512 that corresponds to each key.

The mobile computing device 510 may include mechanical or touch sensitive buttons 518a-d. Additionally, the mobile computing device may include buttons for adjusting volume output by the one or more speakers 520, and a button for turning the mobile computing device on or off. A microphone 522 allows the mobile computing device 510 to convert audible sounds into an electrical signal that may be digitally encoded and stored in computer-readable memory, or transmitted to another computing device. The mobile computing device 510 may also include a digital compass, an accelerometer, proximity sensors, and ambient light sensors.

An operating system may provide an interface between the mobile computing device's hardware (e.g., the input/output mechanisms and a processor executing instructions retrieved from computer-readable medium) and software. The operating system may provide a platform for the execution of application programs that facilitate interaction between the computing device and a user.

The mobile computing device 510 may present a graphical user interface with the touchscreen 512. A graphical user interface is a collection of one or more graphical interface elements and may be static (e.g., the display appears to remain the same over a period of time), or may be dynamic (e.g., the graphical user interface includes graphical interface elements that animate without user input).

A graphical interface element may be text, lines, shapes, images, or combinations thereof. For example, a graphical interface element may be an icon that is displayed on the desktop and the icon's associated text. In some examples, a graphical interface element is selectable with user-input. For example, a user may select a graphical interface element by pressing a region of the touchscreen that corresponds to a display of the graphical interface element. In some examples, the user may manipulate a trackball to highlight a single graphical interface element as having focus. User-selection of a graphical interface element may invoke a pre-defined action by the mobile computing device. In some examples, selectable graphical interface elements further or alternatively correspond to a button on the keyboard 504. User-selection of the button may invoke the pre-defined action.

The mobile computing device 510 may include other applications, computing sub-systems, and hardware. A voice recognition service 572 may receive voice communication data received by the mobile computing device's microphone 522, and translate the voice communication into corresponding textual data or perform voice recognition. The processed voice data can be input to the command models stored in the command models data 122 to determine whether the voice input used to generate the voice data invokes a particular action for a particular application as described above. One or more of the applications, services and units below may have corresponding actions invoked by such voice commands.

A call handling unit may receive an indication of an incoming telephone call and provide a user the capability to answer the incoming telephone call. A media player may allow a user to listen to music or play movies that are stored in local memory of the mobile computing device 510. The mobile device 510 may include a digital camera sensor, and corresponding image and video capture and editing software. An Internet browser may enable the user to view content from a web page by typing in an addresses corresponding to the web page or selecting a link to the web page.

A service provider that operates the network of base stations may connect the mobile computing device 510 to the network 550 to enable communication between the mobile computing device 510 and other computing systems that provide services 560. Although the services 560 may be provided over different networks (e.g., the service provider's internal network, the Public Switched Telephone Network, and the Internet), network 550 is illustrated as a single network. The service provider may operate a server system 552 that routes information packets and voice data between the mobile computing device 510 and computing systems associated with the services 560.

The network 550 may connect the mobile computing device 510 to the Public Switched Telephone Network (PSTN) 562 in order to establish voice or fax communication between the mobile computing device 510 and another computing device. For example, the service provider server system 552 may receive an indication from the PSTN 562 of an incoming call for the mobile computing device 510. Conversely, the mobile computing device 510 may send a communication to the service provider server system 552 initiating a telephone call using a telephone number that is associated with a device accessible through the PSTN 562.

The network 550 may connect the mobile computing device 510 with a Voice over Internet Protocol (VoIP) service 564 that routes voice communications over an IP network, as opposed to the PSTN. For example, a user of the mobile computing device 510 may invoke a VoIP application and initiate a call using the program. The service provider server system 552 may forward voice data from the call to a VoIP service, which may route the call over the internet to a corresponding computing device, potentially using the PSTN for a final leg of the connection.

An application store 566 may provide a user of the mobile computing device 510 the ability to browse a list of remotely stored application programs that the user may download over the network 550 and install on the mobile computing device 510. The application store 566 may serve as a repository of applications developed by third-party application developers. An application program that is installed on the mobile computing device 510 may be able to communicate over the network 550 with server systems that are designated for the application program. For example, a VoIP application program may be downloaded from the Application Store 566, enabling the user to communicate with the VoIP service 564.

The mobile computing device 510 may access content on the internet 568 through network 550. For example, a user of the mobile computing device 510 may invoke a web browser application that requests data from remote computing devices that are accessible at designated universal resource locations. In various examples, some of the services 560 are accessible over the internet.

The mobile computing device may communicate with a personal computer 570. For example, the personal computer 570 may be the home computer for a user of the mobile computing device 510. Thus, the user may be able to stream media from his personal computer 570. The user may also view the file structure of his personal computer 570, and transmit selected documents between the computerized devices.

The mobile computing device 510 may communicate with a social network 574. The social network may include numerous members, some of which have agreed to be related as acquaintances. Application programs on the mobile computing device 510 may access the social network 574 to retrieve information based on the acquaintances of the user of the mobile computing device. For example, an “address book” application program may retrieve telephone numbers for the user's acquaintances. In various examples, content may be delivered to the mobile computing device 510 based on social network distances from the user to other members in a social network graph of members and connecting relationships. For example, advertisement and news article content may be selected for the user based on a level of interaction with such content by members that are “close” to the user (e.g., members that are “friends” or “friends of friends”).

The mobile computing device 510 may access a personal set of contacts 576 through network 550. Each contact may identify an individual and include information about that individual (e.g., a phone number, an email address, and a birthday). Because the set of contacts is hosted remotely to the mobile computing device 510, the user may access and maintain the contacts 576 across several devices as a common set of contacts.

The mobile computing device 510 may access cloud-based application programs 578. Cloud-computing provides application programs (e.g., a word processor or an email program) that are hosted remotely from the mobile computing device 510, and may be accessed by the device 510 using a web browser or a dedicated program.

Mapping service 580 can provide the mobile computing device 510 with street maps, route planning information, and satellite images. The mapping service 580 may also receive queries and return location-specific results. For example, the mobile computing device 510 may send an estimated location of the mobile computing device and a user-entered query for “pizza places” to the mapping service 580. The mapping service 580 may return a street map with “markers” superimposed on the map that identify geographical locations of nearby “pizza places.”

Turn-by-turn service 582 may provide the mobile computing device 510 with turn-by-turn directions to a user-supplied destination. For example, the turn-by-turn service 582 may stream to device 510 a street-level view of an estimated location of the device, along with data for providing audio commands and superimposing arrows that direct a user of the device 510 to the destination.

Various forms of streaming media 584 may be requested by the mobile computing device 510. For example, computing device 510 may request a stream for a pre-recorded video file, a live television program, or a live radio program.

A micro-blogging service 586 may receive from the mobile computing device 510 a user-input post that does not identify recipients of the post. The micro-blogging service 586 may disseminate the post to other members of the micro-blogging service 586 that agreed to subscribe to the user.

A search engine 588 may receive user-entered textual or verbal queries from the mobile computing device 510, determine a set of Internet-accessible documents that are responsive to the query, and provide to the device 510 information to display a list of search results for the responsive documents. In examples where a verbal query is received, the voice recognition service 572 may translate the received audio into a textual query that is sent to the search engine.

These and other services may be implemented in a server system 590. A server system may be a combination of hardware and software that provides a service or a set of services. For example, a set of physically separate and networked computerized devices may operate together as a logical server system unit to handle the operations necessary to offer a service to hundreds of computing devices. A server system is also referred to herein as a computing system.

In various implementations, operations that are performed “in response to” or “as a consequence of” another operation (e.g., a determination or an identification) are not performed if the prior operation is unsuccessful (e.g., if the determination was not performed). Operations that are performed “automatically” are operations that are performed without user intervention (e.g., intervening user input). Features in this document that are described with conditional language may describe implementations that are optional. In some examples, “transmitting” from a first device to a second device includes the first device placing data into a network for receipt by the second device, but may not include the second device receiving the data. Conversely, “receiving” from a first device may include receiving the data from a network, but may not include the first device transmitting the data.

“Determining” by a computing system can include the computing system requesting that another device perform the determination and supply the results to the computing system. Moreover, “displaying” or “presenting” by a computing system can include the computing system sending data for causing another device to display or present the referenced information.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a user computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method performed by data processing apparatus, the method comprising:
receiving, at a data processing apparatus, an indication that a user accessed a resource in which a set of a plurality of items are displayed;
in response to receiving the indication, receiving, at the data processing apparatus, data describing a purchase intent for the set of the plurality of items, the purchase intent being for a user;
receiving, at the data processing apparatus, from each offeror in a set of offerors:
a corresponding offer from the offeror, each offer eligible to be applied to the plurality of items in the set of items and specifying at least one item combination criterion that must be satisfied by combinations of items in the set of items and that must be satisfied for the offer to be applied to the set of items; and
a corresponding valuation of the offer by the offeror for presentation of the offer to the user;
for each offer in the set of offers for which a combination of items in the set of items satisfies the item combination criterion:
determining, by the data processing apparatus, a corresponding utility value to the user based on a user utility model that is a probability function that the user will accept the offer, the determining comprising, for each offer, the determining comprising:
quantifying an incentive of the offer, wherein quantifying the incentive of the offer comprises:
determining an undiscounted price for the set of items;
applying the incentive to the set of items;
determining, from the application of the incentive to the set of items, a discount price for the set of items; and
quantifying the incentive based on the difference between the undiscounted price and the discounted price;
providing the quantification of the incentive to the probability function as an input; and
adjusting the valuation for the offer based on the corresponding utility value;
providing, to the user a given offer selected to be display concurrently with the set of items, wherein the given offer is selected based on the adjusted valuation of the selected offer.

2. The computer-implemented method of claim 1, wherein:
receiving the corresponding valuation of the offer by the offeror comprises receiving a bid from the offeror that represents an amount the offeror is willing to pay in an auction for presentation of the offer to the user; and
adjusting the valuation for the offer based on the corresponding utility value determined for the offer to generate an adjusted valuation for the offer comprises adjusting the bid for the offer based on the corresponding utility value determined for the offer to generate an adjusted bid for the offer.

3. The computer-implemented method of claim 2, further comprising:
submitting the adjusted bids to an auction process and receiving data identifying a selected offer, the selected offer being an offer having an adjusted bid and a corresponding auction score that wins the auction; and
providing, for presentation on a user device, data describing the selected offer.

4. The computer-implemented method of claim 1, wherein:
at least two or more offers each specify an incentive to accept the offer; and
at least two of the offers specify incentives different from each other.

5. The computer-implemented method of claim 1, wherein the user utility model is based on a probability function that the user will accept the offer.

6-7. (canceled)

8. The computer-implemented method of claim 4, wherein at least one incentive is a percentage discount on a total price for all of the items in the set of items.

9. The computer-implemented method of claim 4, wherein at least one incentive is an incentive to purchase an additional item not included in the set of items.

10. The computer-implemented method of claim 4, wherein at least one incentive is an incentive for the user to visit a retail location of the offeror.

11. The computer-implemented method of claim 1, wherein the probability function is a system model trained on user history data specifying purchases of sets of items, wherein:
at least a first subset of the sets of items purchased were purchased subject to an acceptance of an offer applied to one or more items in the set of items and specifying an incentive to accept the offer; and
at least a second subset of the sets of items purchased were purchased subject to a rejection of an offer applied to one or more items in the set of items and specifying an incentive to accept the offer.

12. The computer-implemented method of claim 11, wherein at least a third subset of the sets of items purchased were purchased not subject to an acceptance or rejection of an offer.

13. The computer-implemented method of claim 3, wherein the auction process is a cost per impression auction.

14. A system, comprising:
a data processing apparatus; and
a computer storage medium encoded with a computer program, the program comprising instructions that when executed by the data processing apparatus cause the data processing apparatus to perform operations comprising:
receiving, at a data processing apparatus, an indication that a user accessed a resource in which a set of a plurality of items are displayed;
in response to receiving the indication, receiving, at the data processing apparatus, data describing a purchase intent for the set of the plurality of items, the purchase intent being for a user;
receiving, at the data processing apparatus, from each offeror in a set of offerors:
a corresponding offer from the offeror, each offer eligible to be applied to the plurality of items in the set of items and specifying at least one item combination criterion that must be satisfied by combinations of items in the set of items and that must be satisfied for the offer to be applied to the set of items; and
a corresponding valuation of the offer by the offeror for presentation of the offer to the user;
for each offer in the set of offers for which a combination of items in the set of items satisfies the item combination criterion:
determining, by the data processing apparatus, a corresponding utility value to the user based on a user utility model that is a probability function that the user will accept the offer, the determining comprising, for each offer, the determining comprising:
quantifying an incentive of the offer, wherein quantifying the incentive of the offer comprises:
determining an undiscounted price for the set of items;
applying the incentive to the set of items;
determining, from the application of the incentive to the set of items, a discount price for the set of items; and
quantifying the incentive based on the difference between the undiscounted price and the discounted price;
providing the quantification of the incentive to the probability function as an input; and
adjusting the valuation for the offer based on the corresponding utility value;
providing, to the user a given offer selected to be display concurrently with the set of items, wherein the given offer is selected based on the adjusted valuation of the selected offer.

15. The system of claim 14, wherein:
receiving the corresponding valuation of the offer by the offeror comprises receiving a bid from the offeror that represents an amount the offeror is willing to pay in an auction for presentation of the offer to the user; and
adjusting the valuation for the offer based on the corresponding utility value determined for the offer to generate an adjusted valuation for the offer comprises adjusting the bid for the offer based on the corresponding utility value determined for the offer to generate an adjusted bid for the offer.

16. The system of claim 15, the operations further comprising:
submitting the adjusted bids to an auction process and receiving data identifying a selected offer, the selected offer being an offer having an adjusted bid and a corresponding auction score that wins the auction; and
providing, for presentation on a user device, data describing the selected offer.

17. The system of claim 14, wherein the user utility model is based on a probability function that the user will accept the offer.

18-19. (canceled)

18. A computer storage medium encoded with a computer program, the program comprising instructions that when executed by data processing apparatus cause the data processing apparatus to perform operations comprising:
receiving, at a data processing apparatus, an indication that a user accessed a resource in which a set of a plurality of items are displayed;
in response to receiving the indication, receiving, at the data processing apparatus, data describing a purchase intent for the set of the plurality of items, the purchase intent being for a user;
receiving, at the data processing apparatus, from each offeror in a set of offerors:
a corresponding offer from the offeror, each offer eligible to be applied to the plurality of items in the set of items and specifying at least one item combination criterion that must be satisfied by combinations of items in the set of items and that must be satisfied for the offer to be applied to the set of items; and
a corresponding valuation of the offer by the offeror for presentation of the offer to the user;
for each offer in the set of offers for which a combination of items in the set of items satisfies the item combination criterion:
determining, by the data processing apparatus, a corresponding utility value to the user based on a user utility model that is a probability function that the user will accept the offer, the determining comprising, for each offer, the determining comprising:
quantifying an incentive of the offer, wherein quantifying the incentive of the offer comprises:
determining an undiscounted price for the set of items;
applying the incentive to the set of items;
determining, from the application of the incentive to the set of items, a discount price for the set of items; and
quantifying the incentive based on the difference between the undiscounted price and the discounted price;
providing the quantification of the incentive to the probability function as an input; and
adjusting the valuation for the offer based on the corresponding utility value;
providing, to the user a given offer selected to be display concurrently with the set of items, wherein the given offer is selected based on the adjusted valuation of the selected offer.

20. The computer-implemented method of claim 1, wherein:
at least one offer specifies an incentive of adding an additional item to the set of items not included in the set of items at a discounted price.

21. The system of claim 14, wherein:
at least one offer specifies an incentive of adding an additional item to the set of items not included in the set of items at a discounted price.

22. The computer storage medium of claim 20, wherein:
at least one offer specifies an incentive of adding an additional item to the set of items not included in the set of items at a discounted price.
